(19) United States
(12) Patent Application Publication
(10) Pub. No.: US 2021/0243035 A1
(43) Pub. Date: Aug. 5, 2021

(54) MULTI-FACTOR AUTHENTICATION ENABLED MEMORY SUB-SYSTEM

(71) Applicant: Micron Technology, Inc., Boise, ID (US)

(72) Inventors: James Ruane, San Jose, CA (US); Robert W. Strong, Folsom, CA (US)

(21) Appl. No.: 16/780,532

(22) Filed: Feb. 3, 2020

(51) Int. Cl. H04L 9/32; H04L 9/08; G06F 3/06

(52) U.S. Cl. CPC H04L 9/3247; H04L 9/088; G06F 3/0679; G06F 3/0655; G06F 3/0622

(57) ABSTRACT

A request is received from a host system to initiate an authentication session. Challenge data is generated based on the request and provided to the host system in response to the request. Authentication data is received from the host system. The authentication data comprises a digital signature and enablement data. The digital signature is generated by cryptographically signing the enablement data using a private key, and the enablement data comprises at least the challenge data. The digital signature is validated based on the challenge data and using a public key corresponding to the private key. Access to at least a portion of the data stored in a memory component is provided based at least in part on validating the digital signature.

### TECHNICAL FIELD

Embodiments of the disclosure relate generally to memory sub-systems, and more specifically, relate to multi-factor authentication enabled memory sub-systems.

### BACKGROUND

A memory sub-system can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system configured for multi-factor authentication, in accordance with some embodiments of the present disclosure.

FIG. 2 is a swim-lane diagram illustrating interactions between components in the computing environment in performing an example method for multi-factor authentication, in accordance with some embodiments of the present disclosure.

FIG. 3 is a data flow diagram illustrating interactions between components of the computing environment in performing an example method for multi-factor authentication, in accordance with some embodiments of the present disclosure.

FIGS. 4 and 5 are flow diagrams illustrating an example method for multi-factor authentication in a memory sub-system, in accordance with some embodiments of the present disclosure.

FIG. 6 is a block diagram of an example computer system in which embodiments of the present disclosure may operate.

### DETAILED DESCRIPTION

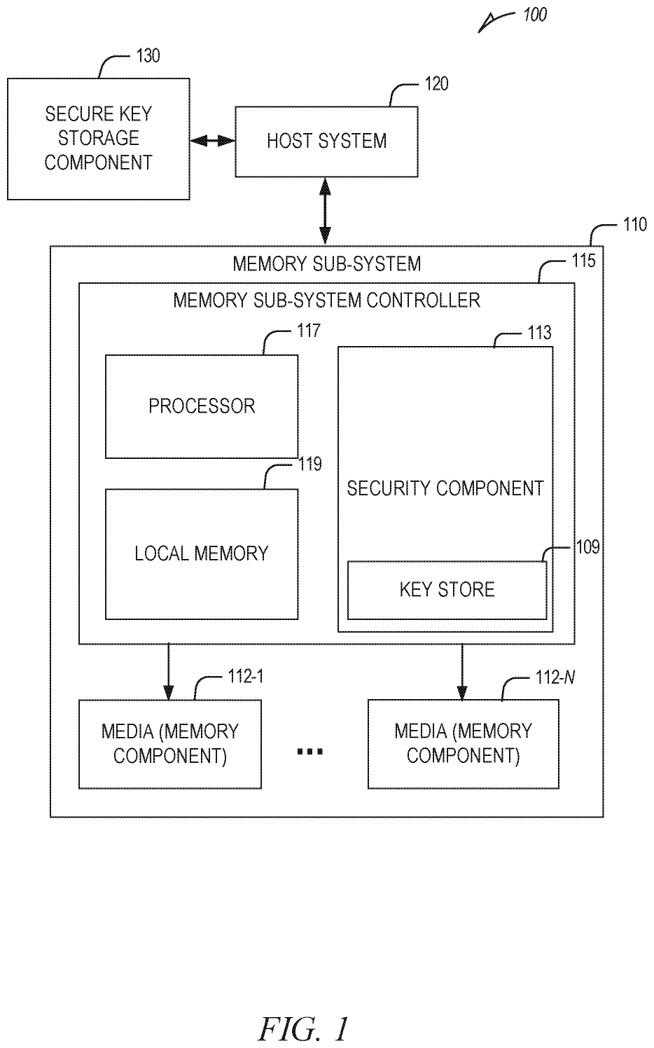

Aspects of the present disclosure are directed to multi-factor authentication in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more memory devices that store data. The host system can provide data to be stored at the memory sub-system and can request data to be retrieved from the memory sub-system.

A memory sub-system can store confidential, proprietary, or other sensitive information that should only be accessed by specifically authorized users. Aspects of the present disclosure address the foregoing and other issues by implementing a multi-factor authentication process for accessing a memory sub-system that prevents unauthorized access to information stored by the memory sub-system. The memory sub-system can be configured to prevent access to data stored therein unless and until the multi-factor authentication process is successfully performed.

As part of the multi-factor authentication process, a public key of an asymmetric key pair (also referred to herein as “cryptographic keys”) is provisioned to a memory sub-system (e.g., during user configuration of the memory sub-system) while the private key is maintained within a secure environment such as a hardware security module (HSM) of an enterprise server, a trusted platform module (TPM), or a smart card that is external to and independent of the memory sub-system.

A host system submits a request to the memory sub-system to initiate an authentication session with the memory sub-system. The request can, in some embodiments, include a request to access specific data stored by the memory sub-system (e.g., a particular folder or directory of a file system stored by the memory sub-system). In response to the request, a memory sub-system controller generates and returns challenge data to the host system. The host system can, in turn, generate enablement data based on the challenge data, and in some embodiments, a user-supplied password. The host system further generates a digital signature based on the enablement data. For example, the host system may generate an asymmetric cryptographic signature using a cryptographic algorithm such as the Rivest Shamir Adleman (RSA) algorithm. The signing of the enablement data may occur within the secure environment. The host system provides authentication data comprising the enablement data and the digital signature to the memory sub-system controller. The memory sub-system controller validates the digital signature using the public key and verifies the enablement data.

Based on successful validation of the digital signature and verification of the enablement data, the memory sub-system controller enables access to at least a portion of the data stored by the memory sub-system. For example, the memory sub-system controller can enable access to data specified in the initial request. It shall be appreciated that utilization of the multi-factor authentication process described above in memory sub-systems reduces vulnerabilities by ensuring that data stored by the memory sub-system is only accessed by authorized parties.

FIG. 1 illustrates an example computing environment 100 that includes a memory sub-system 110, in accordance with some embodiments of the present disclosure. The memory sub-system 110 can include media, such as memory components 112-1 to 112-N (also hereinafter referred to as “memory devices”). The memory components 112-1 to 112-N can be volatile memory components, non-volatile memory components, or a combination of such. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a universal serial bus (USB) interface, a Fibre Channel interface, a Serial Attached SCSI (SAS) interface, a system management bus (SMBus), an Inter-Integrated Circuit (I2C) bus), and so forth. The physical host interface can be used to transmit data between the host system 120 and the memory sub-system 110. The host system 120 can further utilize an NVM Express (NVMe) interface to access the memory components 112-1 to 112-N when the memory sub-system 110 is coupled with the host system 120 by the PCIe interface. The physical host interface can provide an interface for passing control, address, data, and other signals between the memory sub-system 110 and the host system 120.

The memory components 112-1 to 112-N can include any combination of the different types of non-volatile memory components and/or volatile memory components. An example of non-volatile memory components includes a negative-and (NAND)-type flash memory. Each of the memory components 112-1 to 112-N can include one or more arrays of memory cells such as single-level cells (SLCs) or multi-level cells (MLCs), triple-level cells (TLCs), or quad-level cells (QLCs). In some embodiments, a particular memory component can include both an SLC portion and another type (e.g., MLC, TLC. QLC) of portion of memory cells. Each of the memory cells can store one or more bits of data used by the host system 120. Although non-volatile memory components such as NAND-type flash memory are described, the memory components 112-1 to 112-N can be based on any other type of memory such as a volatile memory. In some embodiments, the memory components 112-1 to 112-N can be, but are not limited to, random access memory (RAM), read-only memory (ROM), dynamic random access memory (DRAM), synchronous dynamic random access memory (SDRAM), phase change memory (PCM), magneto random access memory (MRAM), negative-or (NOR) flash memory, electrically erasable programmable read-only memory (EEPROM), and a cross-point array of non-volatile memory cells. A cross-point array of non-volatile memory cells can perform bit storage based on a change of bulk resistance in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, as noted above, the memory cells of the memory components 112-1 to 112-N can be grouped to form pages that can refer to a unit of the memory component used to store data. With some types of memory (e.g., NAND), pages can be grouped to form blocks.

A memory sub-system controller 115 (hereinafter referred to as a “controller”) can communicate with the memory components 112-1 to 112-N to perform operations such as reading data, writing data, or erasing data at the memory components 112-1 to 112-N, and other such operations. The controller 115 can include hardware such as one or more integrated circuits and/or discrete components, a buffer memory, or a combination thereof. The controller 115 can be a microcontroller, special-purpose logic circuitry (e.g., a field-programmable gate array (FPGA), an application-specific integrated circuit (ASIC), etc.), or another suitable processor. The controller 115 can include a processor (processing device) 117 configured to execute instructions stored in local memory 119. In the illustrated example, the local memory 119 of the controller 115 includes an embedded memory configured to store instructions for performing various processes, operations, logic flows, and routines that control operation of the memory sub-system 110, including handling communications between the memory sub-system 110 and the host system 120. In some embodiments, the local memory 119 can include memory registers storing memory pointers, fetched data, etc. The local memory 119 can also include ROM for storing micro-code. While the example memory sub-system 110 in FIG. 1 has been illustrated as including the controller 115, in another embodiment of the present disclosure, a memory sub-system 110 may not include a controller 115, and can instead rely upon external control (e.g., provided by an external host, or by a processor or controller separate from the memory sub-system).

In general, the controller 115 can receive commands or operations from the host system 120 and can convert the commands or operations into instructions or appropriate commands to achieve the desired access to the memory components 112-1 to 112-N. The controller 115 can be responsible for other operations such as wear leveling operations, garbage collection operations, error detection and error-correcting code (ECC) operations, encryption operations, caching operations, and address translations between a logical block address and a physical block address that are associated with the memory components 112-1 to 112-N. The controller 115 can further include host interface circuitry to communicate with the host system 120 via the physical host interface. The host interface circuitry can convert the commands received from the host system 120 into command instructions to access the memory components 112-1 to 112-N as well as convert responses associated with the memory components 112-1 to 112-N into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the controller 115 and decode the address to access the memory components 112-1 to 112-N.

The memory sub-system 110 also includes a security component 113 that facilitates multi-factor authentication with the memory sub-system 110. The security component 113 can be included in the controller 115 or any one or more of the memory components 112-1 to 112-N. In some embodiments, the controller 115 includes at least a portion of the security component 113. For example, the controller 115 can include the processor 117 (processing device) configured to execute instructions stored in the local memory 119 for performing the operations of the security component 113 described herein. In some embodiments, the security component 113 is part of the host system 120, an application, or an operating system.

The security component 113 can further include a key store 109 to store one or more cryptographic keys used by the security component 113 to encrypt and/or verify information. For example, the key store 109 can store a public key used by the security component 113 to encrypt information or verify information signed using a corresponding private key maintained by a secure key storage component 130. In some embodiments, the key store 109 is implemented within a local memory of the memory sub-system controller 115 (e.g., the local memory 119). In some embodiments, the key store 109 is implemented within one or more of the memory components 112-1 to 112-N. The key store 109 can be implemented within a non-volatile memory such that cryptographic keys stored therein are not lost upon system reboot.

To initiate the multi-factor authentication process, the memory sub-system 110 receives a request from the host system 120. The request can, in some embodiments, include a request to access specific data stored by the memory sub-system 110 (e.g., a particular folder or directory of a file system stored by the memory sub-system 110). In response to the request, the security component 113 generates and returns challenge data comprising at least a random number to the host system 120. The host system 120 can, in turn, generate enablement data based on the challenge data, and in some embodiments, a user-supplied password. The host system 120 further generates a digital signature based on the enablement data using the private key maintained by the secure key storage component 130. The host system 120 provides authentication data comprising the enablement data and the digital signature to the security component 113. The security component 113 validates the digital signature using a public key and verifies the enablement data.

Based on successful validation of the digital signature and verification of the enablement data, the security component 113 enables access to at least a portion of the data stored by the memory components 112-1 to 112-N (e.g., access to data specified in the initial request). The details of the multi-factor authentication process described above can be hidden or mostly obscured from the user of the host system 120. For example, from the perspective of the user, a request to access data is made (along with inputting a password, in some embodiments) and the user is provided access to the requested data as long as proper communication is enabled between the host system 120 and the secure key storage component 130.

In some embodiments, the secure key storage component 130 can be or include a smart card. A smart card is a device that includes embedded circuitry to perform one or more functions and includes an internal memory to store at least the private key. The smart card can connect to a reader component (not shown) with direct physical contact or with a remote contactless radio frequency interface. The reader component can read information from the smart card and communicate with the host system 120 via an interface. For example, the memory sub-system 110 can include an application programming interface (API) that allows the reader component to exchange information with the security component 113 of the controller 115. In some embodiments, a user may need to supply a personal identification number (PIN) to the smart card in order to access information stored by the smart card such as the private key. In embodiments in which a smart card is utilized to store the private key, the multi-factor authentication process binds the memory sub-system 110 to a particular user—the user to whom the smart card is assigned. Consistent with these embodiments, the memory sub-system 110 will remain in a locked state in which no data can be accessed until the smart card is read by the reader component.

In some embodiments, the secure key storage component 130 can be or include a trusted platform module (TPM). A TPM is a specialized chip embedded in the host system 120 that stores a private key that is specific to the host system 120 for authentication. In embodiments in which a TPM is utilized to store the private key, the multi-factor authentication process binds the memory sub-system 110 to the host system 120.

In some embodiments, the secure key storage component 130 can be or include an HSM of an enterprise server that forms part of an enterprise network on which the host system 120 operates. Consistent with these embodiments, the security component 113 can communicate and exchange data with the secure key storage component 130 via a wired or wireless network connection. In embodiments in which an HSM of an enterprise server is utilized to store the private key, the multi-factor authentication process binds the memory sub-system 110 to the enterprise network.

The security component 113 can communicate with the host system 120 via the physical host interface or a native sideband communication port (e.g., a Universal Asynchronous Receiver/Transmitter (UART) port or other serial communication port that supports two-way communication) that can be specially configured as a diagnostic or maintenance port.

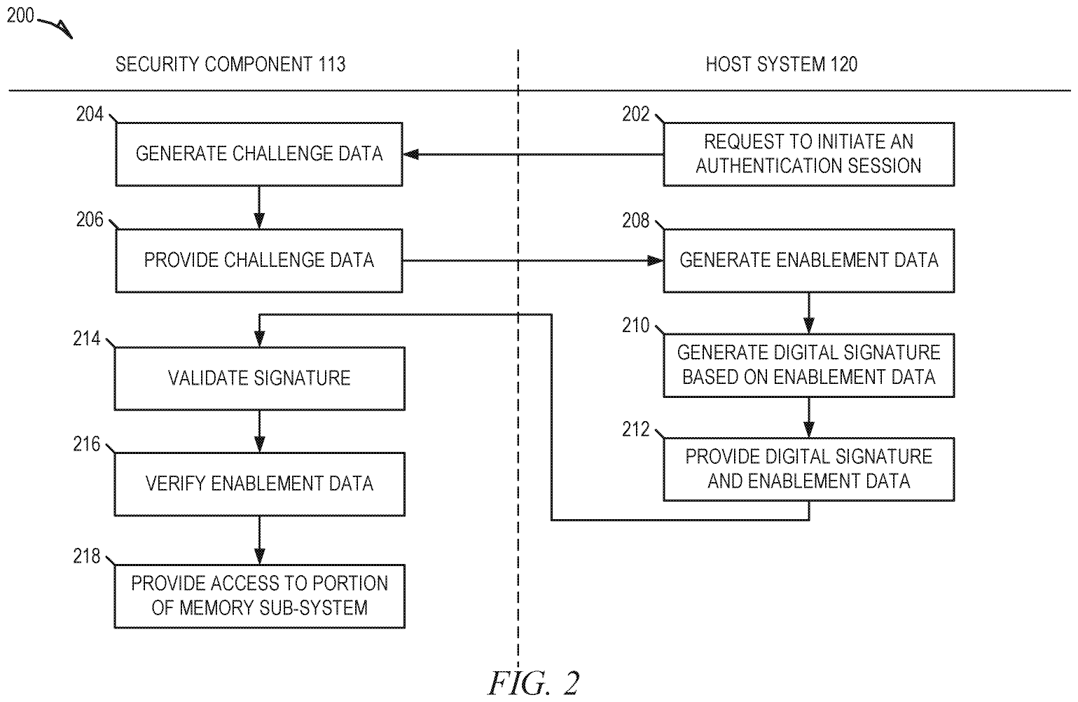

FIG. 2 is a swim-lane diagram illustrating interactions between components in the computing environment 100 in performing an example method 200 for multi-factor authentication, in accordance with some embodiments of the present disclosure. Prior to the method 200, an asymmetric encryption key pair—a public key and a private key—is pre-generated, and the security component 113 is provisioned with the public key, while the secure key storage component 130 maintains the private key. The security component 113 stores the public key in the key store 109. Further, the memory sub-system 110 is configured to prevent access to data until the method 200 is performed.

As shown in FIG. 2, the method 200 begins at operation 202 where the host system 120 sends a request to the security component 113 to initiate an authentication session with the memory sub-system 110 (e.g., to access data stored by the memory sub-system 110). The request can, in some embodiments, specify particular data to be accessed.

Based on receiving the request, the security component 113 generates challenge data at operation 204. The challenge data comprises at least a cryptographic nonce to ensure anti-replay protection. The cryptographic nonce comprises a random number. Accordingly, the generating of the challenge data comprises generating a random number. The security component 113 can utilize one of many known random number generating techniques to generate the random number. In some embodiments, the challenge data can further include additional fields for device-specific information that can include identifiers associated with the device along with other information describing aspects of the device (e.g., a manufacturing identifier). The security component 113 provides the challenge data to the host system 120 in response to the request, at operation 206. Including device-specific information in the challenge data ensures that the challenge data can only have been generated by the memory sub-system controller and prevents another device from being able to reproduce the challenge data.

At operation 208, the host system 120 generates enablement data based on the challenge data. The enablement data comprises at least the cryptographic nonce, and in some embodiments, can further include a user-supplied password (e.g., via a user interface provided by the host system 120). Accordingly, in these embodiments, the generating of the enablement data comprises combining the challenge data with the user-supplied password.

The host system 120 generates, at operation 210, a digital signature based on the enablement data. The host system 120 generates the digital signature by cryptographically signing the enablement data using the private key maintained by the secure key storage component 130, which is in communication with the host system 120. At operation 212, the host system 120 provides the digital signature and enablement data to the security component 113.

The security component 113 validates the digital signature using the public key, at operation 214. If the security component 113 determines that the digital signature is invalid, authentication fails and the method 200 ends. Otherwise, if the security component 113 determines that the digital signature is valid, the security component 113 verifies the enablement data, at operation 216. The verifying of the enablement data can include verifying a length of the cryptographic nonce included in the enablement data; verifying that the challenge data included in the enablement data matches the challenge data generated at operation 204; and in some embodiments, verifying that a valid password was included in the enablement data. By including a random number only used once (the cryptographic nonce), the challenge data prevents against replay attacks.

At operation 218, the security component 113 provides access to at least a portion of data stored by the memory sub-system 110. In some embodiments, the security component 113 may provide access to the entire set of data stored by the memory sub-system 110. In other embodiments, the security component 113 may provide access to only a subset of the data stored by the memory sub-system 110. For example, the security component 113 may provide access only to requested data specified in the request to initiate the authentication session.

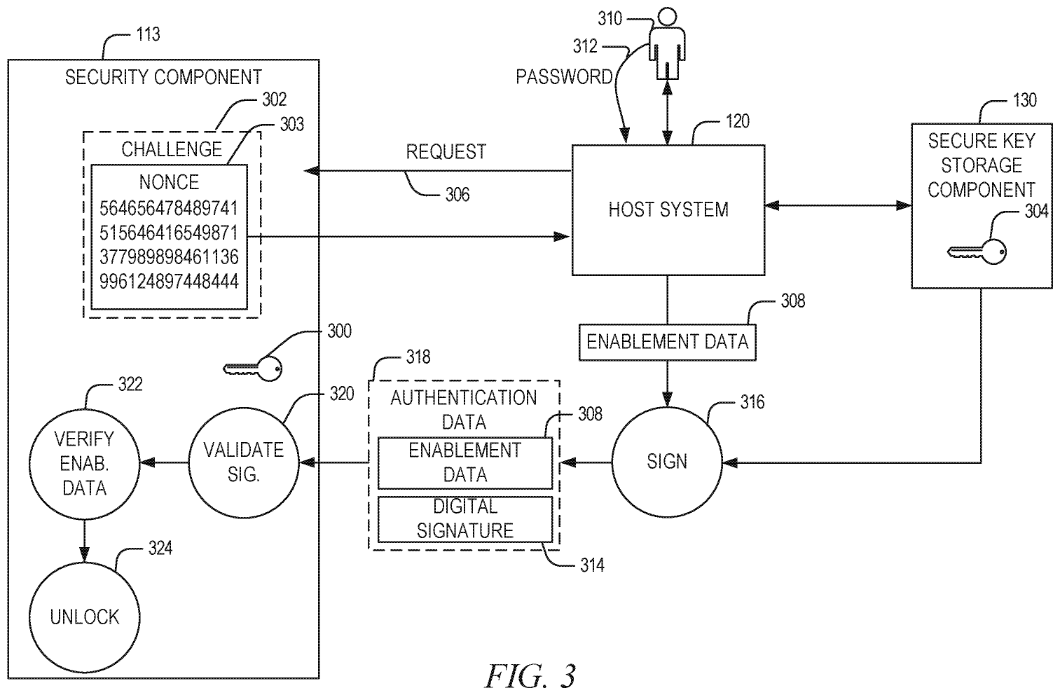

FIG. 3 is a data flow diagram illustrating interactions between components of the computing environment 100 in performing an example method for multi-factor authentication, in accordance with some embodiments of the present disclosure. In the context of FIG. 3, an asymmetric encryption key pair—a public key 300 and a private key 304—can be pre-generated, and the security component 113 can be provisioned with the public key 300, while the secure key storage component 130 maintains the private key 304. The security component 113 stores the public key 300 in the key store 109. The secure key storage component 130 can, in some examples, be or comprise a smart card and/or a smart card reader, a TPM, or an HSM of an enterprise server. The security component 113 prevents access to data stored by the memory sub-system 110 until a multi-factor authentication process is performed as described below.

As shown, the host system 120 sends a request 306 to the security component 113 to initiate an authentication session with the memory sub-system 110. The request 306 can, in some embodiments, specify particular data to be accessed. For example, the request 306 can include a physical block address or other resource identifier corresponding to the requested data. The address or other identifier can identify a location where the requested data is stored on one or more of the memory components 112-1 to 112-N. The address or other identifier can, for example, correspond to a folder or directory of a file system stored by one of the memory components 112-1 to 112-N.

Based on receiving the request, the security component 113 generates challenge data 302 comprising a cryptographic nonce 303. The cryptographic nonce 303 can be included in the challenge data 302 to ensure anti-replay protection. The cryptographic nonce 303 comprises a random number. Accordingly, the generating of the challenge data 302 comprises generating a random number. The security component 113 can utilize one of many known random number generating techniques to generate the random number. The security component 113 provides the challenge data 302 to the host system 120 in response to the request 306.

The host system 120 generates enablement data 308 comprising at least the challenge data 302. In some embodiments, a user 310 of the host system 120 can supply a password 312 (e.g., via a user interface provided by the host system 120) as part of the authentication process. Consistent with these embodiments, the enablement data 308 comprises a combination of the challenge data 302 and the password 312. Accordingly, in these embodiments, the generating of the enablement data 308 comprises combining the challenge data 302 with the password 312.

The host system 120 generates a digital signature 314 based on the enablement data. The host system 120 generates the digital signature 314 by cryptographically signing (at 316) the enablement data 308 using the private key 304 stored by the secure key storage component 130, which is in communication with the host system 120. The host system 120 generates authentication data 318 by combining the digital signature 314 and the enablement data 308, and provides the authentication data 318 to the security component 113.

At 320, the security component 113 validates the digital signature 314 based on the challenged data 302 using the public key 300. If the security component 113 determines that the digital signature 314 is invalid, authentication fails. Otherwise, if the security component 113 determines that the digital signature 314 is valid, the security component 113 verifies the enablement data 308, at 322. As will be discussed in further detail below, the verifying of the enablement data 308 can include verifying a length of the cryptographic nonce 303 included in the enablement data 308; verifying that the challenge data included in the enablement data 308 matches the challenge data 302; and in some embodiments, verifying that the password 312 is valid.

At 324, the security component 113 provides access to at least a portion of data stored by the memory sub-system 110 by unlocking one or more of the memory components 112-1 to 112-N. In some embodiments, the security component 113 may provide access to the entire set of data stored by the memory sub-system 110. In other embodiments, the security component 113 may provide access to only a subset of the data stored by the memory sub-system 110. For example, the security component 113 may provide access only to requested data specified in the request 306. The details of the multi-factor authentication process described above can be hidden or mostly obscured from the user 310. For example, from the perspective of the user 310, a request to access data is made (along with inputting a password, in some embodiments) and the user 310 is provided access as long as proper communication is enabled with the host system 120 and the secure key storage component 130.

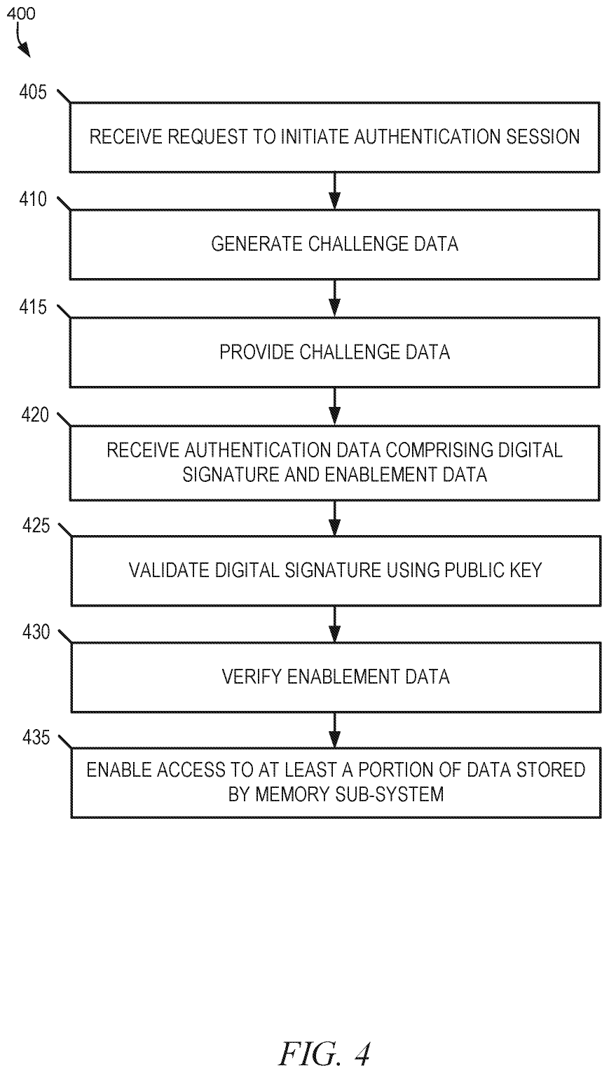

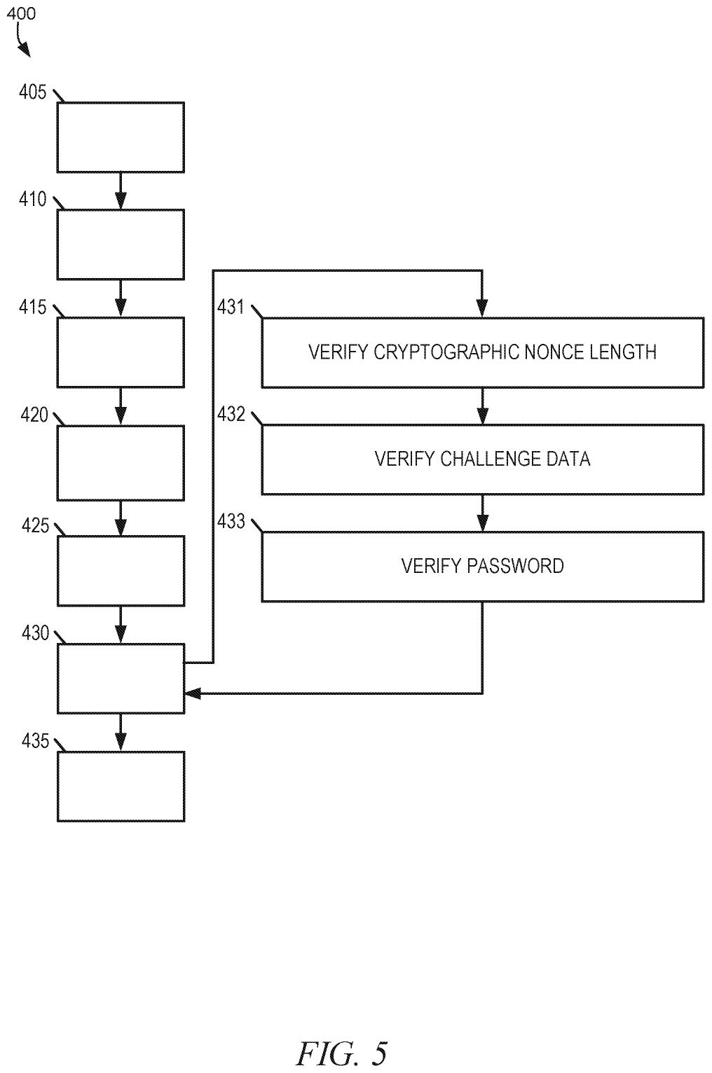

FIGS. 4 and 5 are flow diagrams illustrating an example method 400 for multi-factor authentication in a memory sub-system, in accordance with some embodiments of the present disclosure. The method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 400 is performed by the security component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device receives a request to initiate an authentication session with a memory sub-system. In some embodiments, the request can include a request to access specific data from a memory sub-system (e.g., the memory sub-system 110). For example, the request can include an identifier or address corresponding to one of the memory components 112-1 to 112-N or a portion thereof where the requested data is stored. The requested data may, for example, correspond to a folder or directory of a file system stored by one of the memory components 112-1 to 112-N. The request can be received from the host system 120. In some embodiments, receiving the request includes receiving one or more commands from the host system via a host system interface. In some embodiments, receiving the request includes receiving the request from the host system via a communication port (e.g., a UART port or other serial communication port that supports two-way communication).

The processing device, at operation 410, generates challenge data in response to receiving the request. The challenge data comprises at least a cryptographic nonce. The cryptographic nonce comprises a random number. Accordingly, the generating of the challenge data includes generating a random number. The processing device can generate the random number using one of many known random number generators.

In some embodiments, the challenge data can comprise additional fields for device-specific information describing the memory sub-system that can include identifiers associated with the device along with other information describing aspects of the device. Consistent with these embodiments, the generating of the challenge data may further include combining the cryptographic nonce with the device-specific information.

At operation 415, the processing device provides the challenge data in response to the request. For example, the processing device can return the challenge data to the host system 120 in response to a request received from the host system 120.

The processing device receives authentication data at operation 420. The authentication data comprises enablement data and a digital signature. The enablement data comprises at least the challenge data generated by the processing device. In some embodiments, the enablement data can further comprise a password supplied by the user 310 of the host system 120. The digital signature is generated by cryptographically signing the enablement data using a private key. For example, the host system 120 can use the private key to cryptographically sign the challenge data or a combination of the challenge data and a password, depending on the embodiment.

The processing device validates the digital signature based on the challenge data using a public key corresponding to the private key used to create the digital signature (at operation 425). For example, the processing device can use a public key stored in the key store 109. More specifically, the processing device may utilize the asymmetric cryptographic algorithm used in generating the digital signature (e.g., RSA) to validate the digital signature using the public key.

Consistent with some embodiments, the processing device can validate the digital signature by generating hash data based on the challenge data using the public key, decrypting the digital signature using the public key, and comparing the hash data to the decrypted data to verify that the two values match. If the values do not match (not shown), authentication fails.

Otherwise, the method 400 proceeds to operation 430 where the processing device verifies the enablement data. Further details regarding the verifying of the enablement data are discussed below in reference to FIG. 5.

At operation 435, the processing device enables access to at least a portion of the data stored by the memory sub-system. That is, the processing device unlocks the memory sub-system to allow a user to access data stored thereon. The processing device may unlock one or more memory components or one or more portions of a single memory component.

In some embodiments, the processing device may provide access to only a portion of the data stored by the memory sub-system. Consistent with these embodiments, the portion of the data to which the processing device provides access corresponds to the data specified in the request. Hence, in these embodiments, the processing device may enable access to data stored by only a subset of the memory components of the memory sub-system or only a portion of one of the memory components.

In some embodiments, the processing device provides access to the entire memory sub-system. In other words, the processing device unlocks the entire memory sub-system, thereby allowing a user to access data stored by any one of the memory components of the memory sub-system.

As shown in FIG. 5, the method 400 can, in some embodiments, include operations 431, 432, and 433. Consistent with these embodiments, the operations 431, 432, and 433 can be performed as part of the operation 430, where the processing device verifies the enablement data. At operation 431, the processing device verifies a length of the cryptographic nonce included in the enablement data. That is, the processing device compares the cryptographic nonce generated at operation 410 with the cryptographic nonce included in the authentication data to ensure that the lengths (e.g., the numbers of bits) are identical.

At operation 432, the processing device verifies the challenge data included in the enablement data. That is, the processing device compares the challenge data included in the enablement data with the challenge data generated at operation 410 to confirm that the two values match. The processing device also verifies, at operation 433, a password included in the enablement data to confirm that the correct password has been provided.

### EXAMPLES

Example 1 is a system comprising: a memory component; and a memory sub-system controller, operatively coupled with the memory component, to perform operations comprising: receiving, from a host system, a request to initiate an authentication session with a memory sub-system; generating challenge data in response to the request, the challenge data comprising a cryptographic nonce; providing, to the host system, the challenge data; receiving, from the host system, authentication data comprising a digital signature and enablement data including at least the challenge data, the digital signature being generated by cryptographically signing the enablement data using a private key; validating the digital signature based on the challenge data and using a public key corresponding to the private key; and providing access to at least a portion of data stored by a memory component of a memory sub-system based at least in part on validating the digital signature.

In Example 2, the request of Example 1 optionally comprises a request to access the portion of the data stored in the memory component.

In Example 3, the operations of any one of Examples 1 and 2 optionally comprise generating a random number corresponding to the cryptographic nonce.

In Example 4, the enablement data of any one of Examples 1-3 is optionally a combination of the challenge data with a password.

In Example 5, the operations of any one of Examples 1-4 optionally comprise providing access to at least the portion of the data is based further on verifying the enablement data.

In Example 6, the verifying of the enablement data in any one of Examples 1-5 optionally comprises verifying a length of the cryptographic nonce included in the enablement data; and verifying the challenge data included in the enablement data.

In Example 7, the enablement data of any one of Examples 1-6 optionally comprises a password and the verifying of the enablement in any one of Examples 1-7 optionally comprises verifying the password.

In Example 8, the private key of any one of Examples 1-7 is optionally stored by a smart card that is communicatively coupled to the memory sub-system controller.

In Example 9, the private key of any one of Examples 1-7 is optionally stored by a trusted platform module (TPM) of the host system.

In Example 10, the private key of any one of Examples 1-7 is optionally stored by a hardware security module (HSM) of an enterprise server.

In Example 11, the system of any one of Examples 1-10 optionally comprises a physical host interface to receive the request from the host system.

Example 12 is a method comprising: receiving, from a host system, a request to initiate an authentication session with a memory sub-system; generating, by at least one hardware processor, challenge data in response to the request, the challenge data comprising a cryptographic nonce; providing, to the host system, the challenge data; receiving, from the host system, authentication data comprising a digital signature and enablement data including at least the challenge data, the digital signature being generated by cryptographically signing the enablement data using a private key; validating, by the at least one hardware processor, the digital signature based on the challenge data and using a public key corresponding to the private key; and providing access to at least a portion of data stored by a memory component of a memory sub-system based at least in part on validating the digital signature.

In Example 13, the request of Example 12 optionally comprises a request to access the portion of the data stored in the memory component.

In Example 14, the method of any one of Examples 12 and 13 optionally comprises generating a random number corresponding to the cryptographic nonce.

In Example 15, the enablement data of any one of Examples 12-14 is optionally a combination of the challenge data with a password.

In Example 16, the method of any one of Examples 12-15 optionally comprises providing access to the at least a portion of the data is based further on verifying the enablement data.

In Example 17, the verifying of the enablement data in any one of Examples 12-16 optionally comprises verifying a length of the cryptographic nonce included in the enablement data; and verifying the challenge data included in the enablement data.

In Example 18, the at least one hardware processor of any one of Examples 12-17 optionally corresponds to a controller of a memory sub-system and the request of any one of Examples 12-17 is optionally received via a physical host interface of the memory sub-system.

In Example 19, the private key of any one Examples 12-18 is optionally stored by one of: wherein the private key is stored by one of: a smart card, a trusted platform module (TPM) of the host system, or a hardware security module (HSM) of an enterprise server.

Example 20 is non-transitory computer-readable storage medium comprising instructions that, when executed by a memory sub-system controller, configure the memory sub-system controller to perform operations comprising: receiving, from a host system, a request to initiate an authentication session with a memory sub-system; generating challenge data in response to the request, the challenge data comprising a cryptographic nonce; providing, to the host system, the challenge data; receiving, from the host system, authentication data comprising a digital signature and enablement data including at least the challenge data, the digital signature being generated by cryptographically signing the enablement data using a private key; validating the digital signature based on the challenge data and using a public key corresponding to the private key; and providing access to at least a portion of data stored by a memory component of a memory sub-system based at least in part on validating the digital signature.

### Machine Architecture

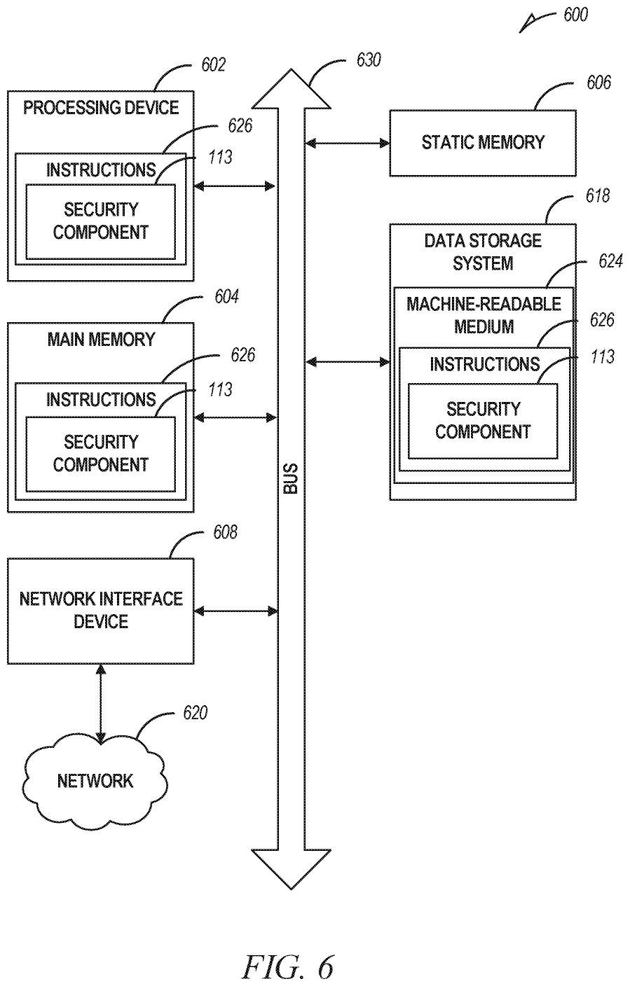

FIG. 6 illustrates an example machine in the form of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the security component 113 of FIG. 1). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory. DRAM such as SDRAM or Rambus DRAM (RDRAM), etc.), a static memory 606 (e.g., flash memory, static random access memory (SRAM), etc.), and a data storage system 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an ASIC, an FPGA, a digital signal processor (DSP), a network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a security component (e.g., the security component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; ROMs; RAMs; erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., a computer-readable) storage medium such as a ROM, a RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory component storing data; and
a memory sub-system controller, operatively coupled with the memory component, to perform operations comprising:
receiving, from a host system, a request to initiate an authentication session with a memory sub-system;
generating challenge data in response to the request, the challenge data comprising a cryptographic nonce;
providing, to the host system, the challenge data;
receiving, from the host system, authentication data comprising a digital signature and enablement data including at least the challenge data, the digital signature being generated by cryptographically signing the enablement data using a private key;
validating the digital signature based on the challenge data and using a public key corresponding to the private key; and
providing access to at least a portion of the data stored by the memory component based at least in part on validating the digital signature.

2. The system of claim 1, wherein:
the request comprises a request to access the portion of the data stored in the memory component.

3. The system of claim 1, wherein the generating of the challenge data comprises:
generating a random number corresponding to the cryptographic nonce; and
combining the random number with device-specific information that describes the system.

4. The system of claim 1, wherein the enablement data received from the host system is a combination of the challenge data and a password.

5. The system of claim 1, wherein:
the operations further comprise verifying the enablement data; and
the providing access to at least the portion of the data is further based on verifying the enablement data.

6. The system of claim 5, wherein the verifying of the enablement data comprises:
verifying a length of the cryptographic nonce included in the enablement data; and
verifying the challenge data included in the enablement data.

7. The system of claim 5, wherein:
the enablement data further comprises a password; and
the verifying of the enablement data comprises verifying the password.

8. The system of claim 1, wherein the private key is stored by a smart card that is communicatively coupled to the memory sub-system controller.

9. The system of claim 1, wherein the private key is stored by a trusted platform module (TPM) of the host system.

10. The system of claim 1, wherein the private key is stored by a hardware security module (HSM) of an enterprise server.

11. The system of claim 1, further comprising:
a physical host interface to receive the request from the host system.

12. A method comprising:
receiving, from a host system, a request to initiate an authentication session with a memory sub-system;
generating, by at least one hardware processor, challenge data in response to the request, the challenge data comprising a cryptographic nonce;
providing, to the host system, the challenge data;
receiving, from the host system, authentication data comprising a digital signature and enablement data including at least the challenge data, the digital signature being generated by cryptographically signing the enablement data using a private key;
validating, by the at least one hardware processor, the digital signature based on the challenge data and using a public key corresponding to the private key; and
providing access to at least a portion of data stored by a memory component of a memory sub-system based at least in part on validating the digital signature.

13. The method of claim 12, wherein:
the request comprises a request to access the portion of the data stored in the memory component.

14. The method of claim 12, wherein the generating of the challenge data comprises:
generating a random number; and
combining the random number with device-specific information describing the memory sub-system.

15. The method of claim 12, wherein the enablement data is generated by the host system by combining the challenge data with a password.

16. The method of claim 12, further comprising verifying the enablement data, wherein the providing access to the at least a portion of the data is further based on verifying the enablement data.

17. The method of claim 16, wherein the verifying of the enablement data comprises:
verifying a length of the cryptographic nonce included in the enablement data; and
verifying the challenge data included in the enablement data.

18. The method of claim 17, wherein:
the at least one hardware processor corresponds to a controller of a memory sub-system; and
the request is received via a physical host interface of the memory sub-system.

19. The method of claim 12, wherein the private key is stored by one of: a smart card, a trusted platform module (TPM) of the host system, or a hardware security module (HSM) of an enterprise server.

20. A non-transitory computer-readable storage medium comprising instructions that, when executed by a memory sub-system controller, configure the memory sub-system controller to perform operations comprising:
receiving, from a host system, a request to initiate an authentication session with a memory sub-system;
generating challenge data in response to the request, the challenge data comprising a cryptographic nonce;
providing, to the host system, the challenge data;
receiving, from the host system, authentication data comprising a digital signature and enablement data including at least the challenge data, the digital signature being generated by cryptographically signing the enablement data using a private key;
validating the digital signature based on the challenge data and using a public key corresponding to the private key; and
providing access to at least a portion of data stored by a memory component of a memory sub-system based at least in part on validating the digital signature.
